(19) United States
(12) Patent Application Publication
(10) Pub. No.: US 2007/0215830 A1
(43) Pub. Date: Sep. 20, 2007

(54) Method and apparatus for providing cleanability to a valve

(75) Inventor: Larry Norton, Elkhorn, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: United Dominion Industries, Inc.

(21) Appl. No.: 11/375,207

(22) Filed: Mar. 15, 2006

(51) Int. Cl. F16K 1/36

(52) U.S. Cl. 251/205

(57) ABSTRACT

A method and apparatus provides cleanability in a valve having a valve body with a radius seal between the seat and the body and an axial movable valve stem. A valve apparatus has a hollow valve body having an inner seat face; a valve disc reciprocally moveable within the valve body; a seal element disposed around the valve disc to contact the inner seat face of the valve body; and a fluid control groove disposed on the seat face, with the flow control groove comprising an annular circumferential groove portion, and a secondary groove portion. The secondary groove portion can be helical or axial.

### FIELD OF THE INVENTION

The present invention relates generally to the field of fluid handling valves. It more particularly relates to providing cleanability in a valve having a valve body with a radial seal between a seat on the body, and an axially movable valve disk.

### BACKGROUND OF THE INVENTION

Fluid control valves are in wide use in industry. One type of such valve, commonly referred to as a double block and bleed valve, has a valve body with two chambers, referred to as an upper chamber and a lower chamber. Between the two chambers is a constricted seat region. A pair of disc-shaped blocks are mounted for axial movement, one in each chamber respectively. There is an upper block which is movable between a sealed position seated against an upper part of the seat area, and a lower block moveable between open and closed positions against a lower part of the seat area. It has been known for these blocks to typically have a disc end which has a circumferential groove that supports a resilient o-ring type seal member that provides a seal between the disc and that respective seat area.

It has also been known for the two discs, when both fully seated, to still have some intermediate space between them which is connected to a bleed vent that leads out of the valve body. In one typical arrangement, the lower seat area and lower disc are dimensioned so that, in an upper most position, the disc and the o-ring seal against the inside of the seat. The seat has an outward taper below the seal area, so that when the lower disc is moved downwardly, the o-ring no longer contacts the enlarged tapered portion of the seat area, and fluid then moves upward above the disc and into the vent area from which it exits. One purpose for this feature has been in so called clean in place devices. In such devices, between normal operating cycles it is known to flush these systems with a cleaning fluid. Thus, in the above-described system, between operations, the disc can be lowered away from the seated position and this will permit cleaning fluid to flow around the peripheral surface of the disc, cleaning the peripheral surface of the disc, and to some extent the exposed portion of the o-ring, as the fluid moves past the disc and into the vent area.

An example of a valve system employing this prior art arrangement is illustrated in FIGS. 8 and 9. FIGS. 8 and 9 illustrate a valve system 101 including a valve assembly 102 that includes a valve that is operating in connection with two fluid conduits 110 and 112. A valve body 114 has an upper body portion 115, a lower body portion 116 and a central body portion 117. The central body portion 117 provides an inwardly facing surface that serves as a sealing seat. A lower valve block 118 is axially moveable and includes a lower disc 120 in the upper region of the valve block 118. The lower disc 120 has a circumferential groove that supports an o-ring 134. The lower disc 120 provides a seal against a seating surface 124.

An upper disc 122 is also provided. The upper valve disc 122 provides a seal against a angled seating surface 126. When both discs 120 and 122 are in the closed sealed configuration, a vent area 130 which leads to a drain bleed out of the body is provided as a space between the two discs.

Sealing of the lower disc 120 with the face 124 is aided by the provision of an o-ring 134 which seals against a sealing face 132. When the lower disc is moved axially downward, the o-ring 134 loses contact with the tapered region 135, permitting fluid to flow in a space between the tapered region 135 and the o-ring 134, so that the fluid continues up into the vent area 130 which leads to the drain/bleed feature.

The above-described arrangement, while being generally satisfactory in many respects, has some disadvantages however. In particular, when this device is constructed in relatively larger sizes, the flow area between the o-ring 134 and the tapered area 135 can end up being greater than desired. Another disadvantage is that it is sometimes desirable to control the flow of the cleaning fluid through this gap, and the above-described system does not provide a very precise control or restriction for throttling of the fluid flow. Further, it can be difficult to find a position where the o-ring itself is subjected to a sufficient amount of cleaning fluid.

Accordingly, it would be desirable to have an apparatus and method that can provide an improved cleaning solution path through a valve such as a double block and bleed valve having a radial seal on a lower disc. It would also be desirable to provide cleanability in a valve having a valve body with a radius seal between the seat and the body and an axial movable valve stem.

### SUMMARY OF THE INVENTION

The foregoing needs are met, to a great extent, by the present invention, wherein in one aspect an apparatus is provided that in some embodiments can provide an improved cleaning solution path through a valve such as a double block and bleed valve having a radial seal on a lower disc. Some embodiments also provide cleanability in a valve having a valve body with a radius seal between the seat and the body and an axial movable valve stem.

In accordance with one embodiment of the present invention, a valve apparatus has a hollow valve body having an inner seat face; a valve disc reciprocally moveable within the valve body; a seal element disposed around the valve disc to contact the inner seat face of the valve body; and a fluid control groove disposed on the seat face, the flow control groove comprising an annular circumferential groove portion, and a secondary groove portion.

In accordance with another embodiment of the present invention, a valve apparatus has a hollow valve body having an inner seat face; a valve disc reciprocally moveable within the valve body; sealing means disposed around the valve disc to contact the inner seat face of the valve body; and a fluid controlling means disposed on the seat face, the flow control groove comprising an annular circumferential groove portion, and a secondary groove portion.

In accordance with yet another embodiment of the present invention, a method of controlling flow in a valve apparatus, involves moving a device comprising: a hollow valve body having an inner seat face; a valve disc reciprocally moveable within the valve body; a seal element disposed around the valve disc to contact the inner seat face of the valve body; and a fluid control groove disposed on the seat face, the flow control groove comprising an annular circumferential groove portion, and a secondary groove portion, wherein the device is moved from (i) a first position at which the seal element is seated against the seat face and prevents flow into the vent region, through (ii) a second position where the o-ring is disposed axially parallel to the circumferential groove region permitting flow around the o-ring, and into (iii) a third position wherein the o-ring is disposed at the axial location of the secondary groove, and permits fluid flow past the o-ring via the secondary groove.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side schematic view of a valve body showing, superimposed to the side, the axial position of a lower stem having a radial seal disc, according to a preferred embodiment of the invention, in a raised, closed, position.

FIG. 2 is a view similar to FIG. 1, but showing the stem and valve disc in a lowered, throttling, position.

FIG. 3 is a side schematic view of a valve body showing, superimposed to the side, the axial position of a lower stem having a radial seal disc, according to an alternative embodiment of the invention, in a raised, closed, position.

FIG. 4 is a view similar to FIG. 3, but showing the stem and disc in a lowered, throttling, position.

FIG. 5 is a detailed view of the alternative embodiment showing the lowered stem and disc in a raised, closed, position.

FIG. 6 is a detailed view of the alternative embodiment showing the lowered stem and disc in an intermediate, o-ring cleaning, position.

FIG. 7 is a detailed view of the alternative embodiment showing the lowered stem and disc in a lowered, throttling, position.

FIG. 8 is a schematic view of a prior art double block and bleed seal.

FIG. 9 is a detailed view of a sealing region of the prior art device illustrated in FIG. 8.

### DETAILED DESCRIPTION

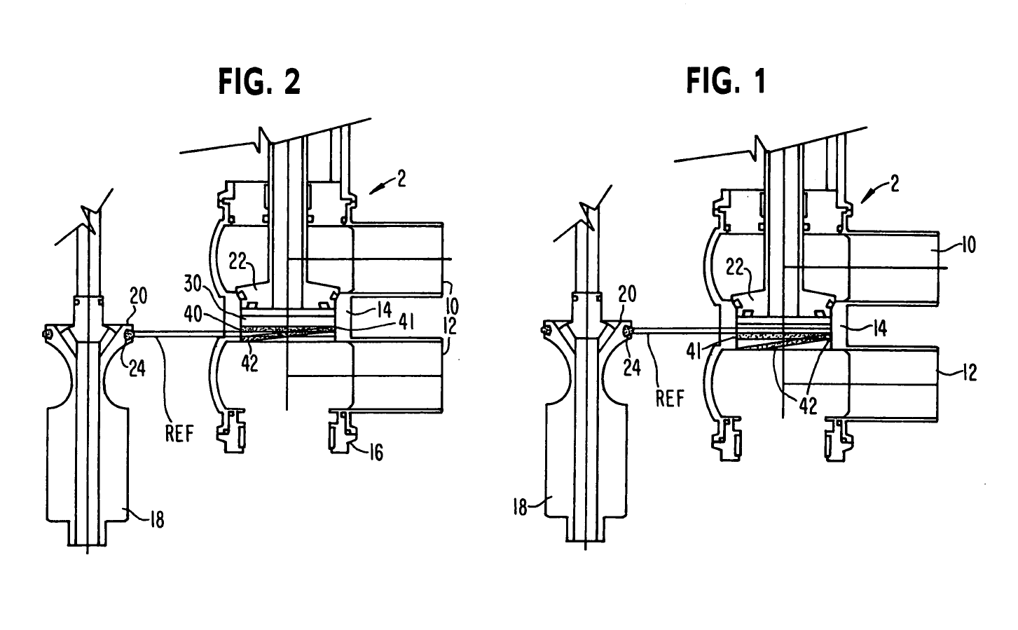

Accordingly, it would be desirable to have an apparatus and method that can provide an improved cleaning solution path through a valve such as a double block and bleed valve having a radial seal on a lower disc. It would also be desirable to provide cleanability in a valve having a valve body with a radius seal between the seat and the body and an axial movable valve stem. FIGS. 1 and 2 illustrate a first preferred embodiment of the present invention. A valve body 2 is illustrated having two flow passages 10 and 12 respectively. Between the flow passages is a central body portion 14, which provides the seats for upper and lower valve disc elements.

The valve body 2 also has a lower body portion 16 which supports and seals against the lower stem portion of a lower valve stem 18. The lower valve stem 18 is axially moveable and has at its upper end a lower valve disc 20 which supports an o-ring 24 that can seal against an inner surface of the central body portion 14.

The assembly 2 also includes an upper valve disc 22 which is also moveable to seal against a sealing face on the central portion 14 of the valve body 2. The inner peripheral surface of the central valve portion 14 also includes a fluid passage groove generally designated 40. The fluid passage groove 40 includes a circumferential first groove 41 which connects with below it a spiral helical groove 42.

FIG. 1 for convenience of illustration shows the upper valve disc 22 in a lowered, closed, seal position. The lower valve stem 18 and lower valve disc 20 are shown superimposed laterally from the valve body but at the axial height at which the lower valve disc 20 would also be in a raised, closed, position. The reference lines labeled REF shows that in this position that the o-ring 24 is seated against a relatively flat and continuous seating face on the inside surface of 14.

Turning to FIG. 2, the reference line REF in this figure shows that the lower valve disc 20 has been moved downward to a lowered, throttling, position at which the o-ring is aligned with the spiral helical groove 42. In this throttling, position, also referred to as a bleed fluid flow control position, the material in the lower passage 12 (such as, for example, a cleaning fluid) would be able to pass through the gap between the o-ring 24 and the helical groove 42 and thus flow upward into a bleed vent area 30. It will be appreciated that the helical groove 42 can be dimensioned so that a predetermined fluid bleed flow will occur at a given pressure.

Also as will be described in more detail below with respect to an alternative embodiment, in this first embodiment when moving between the position of FIG. 1 and FIG. 2, it will be appreciated that the upper valve disc 20 has an intermediate position at which the o-ring 24 would be positioned axially at the same location at the circumferential groove 41. In this position, cleaning fluid also flows up into the vent 30, but also flows completely around the circumference of the o-ring 24, thereby cleaning the full circumference of the o-ring 24.

It will be appreciated that the embodiment of FIGS. 1 and 2 thereby provides a valve seat and valve disc arrangement having three operative positions. In one position, shown in FIG. 1, the o-ring 24 is seated against the seat and the valve is closed and no fluid flows in to the vent 30. In an intermediate position, not shown, which is a position in between the positions of FIGS. 1 and 2, fluid flows completely around the periphery of the o-ring 24 by virtue of the annular groove 41 and flows into the vent 30. In a third position shown in FIG. 2, the o-ring 24 is aligned with the spiral or helical groove 42 and thus fluid flows around the o-ring 24 via the groove 42 in a controlled volumetric fashion.

In the intermediate position, the o-ring 24 is aligned with the circumferential groove 41 and the fluid flow will be greater than the fluid flow in the third position, depending on the depths of the respective grooves 41 and 42.

An alternative embodiment is depicted in FIGS. 4-7. In this embodiment, the components are essentially the same, with the exception that, instead of a groove 40, a different groove 50 is provided on the seat, which includes an annular groove 51 (similar to the annular groove 41 of FIGS. 1 and 2) connected to one or more axial grooves 52. These axial grooves 52 serve a function similar to the helical groove 42 described in the previous embodiment.

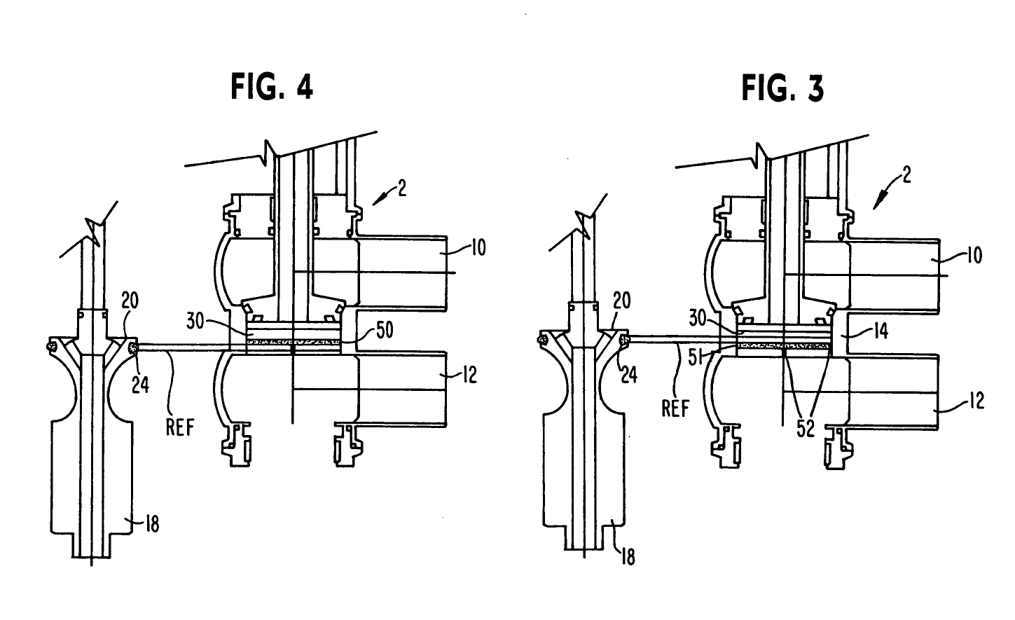

FIG. 3 is similar to FIG. 1 and depicts the lower valve disc 20 in a raised, closed, configuration, with no fluid flowing into the vent 30. FIG. 4 is similar to FIG. 2 and shows the lower disc 20 in a lowered, throttling, position where the o-ring 24 is adjacent the axial groove or grooves 52, and thus cleaning fluid will flow through the axial groove in a volume controlled fashion into the vent 30.

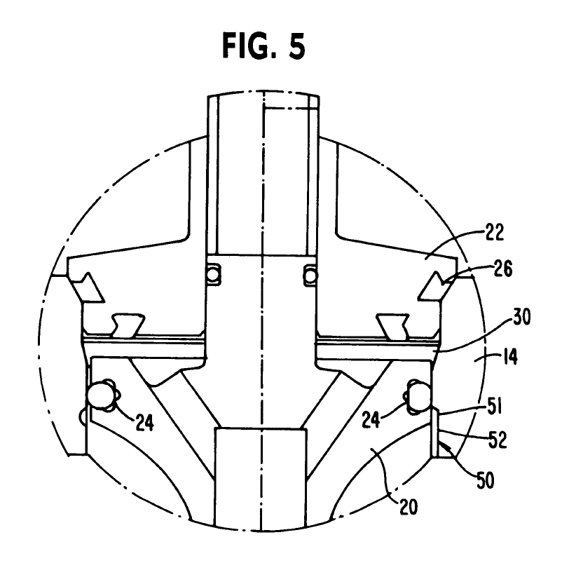

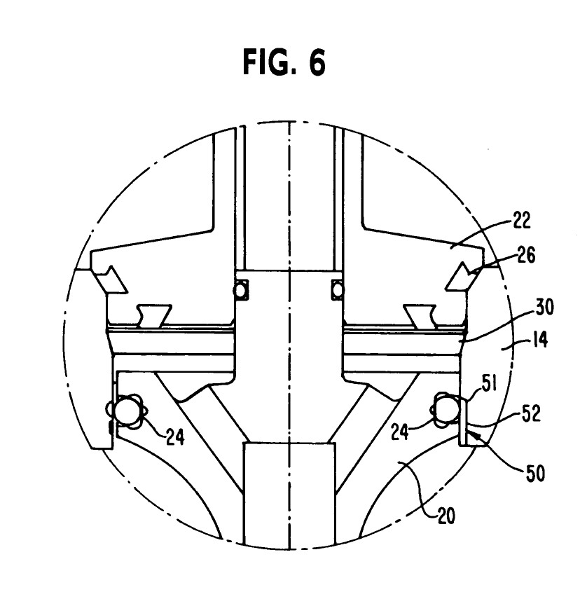

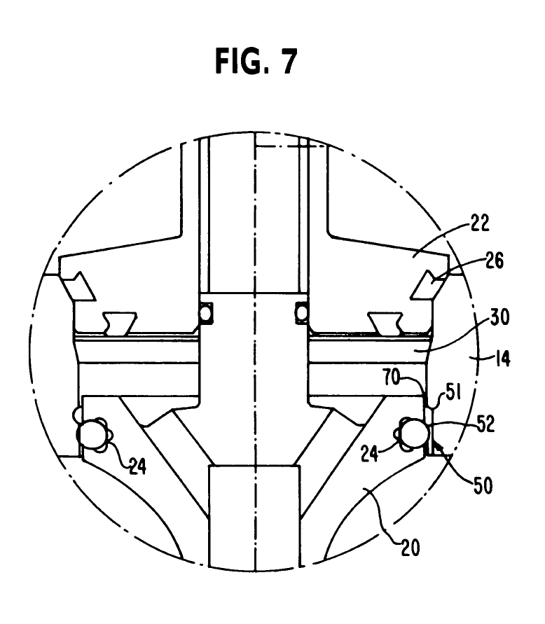

FIGS. 5-7 depict the three operative positions of this valve. FIG. 5 corresponds to the position of FIG. 3 and shows that the valve is closed. FIG. 6 shows an intermediate position wherein cleaning fluid will flow first up the axial groove 52 and then into the circumferential groove 51 thus flowing around the entire outer circumference of the o-ring 24 and past the o-ring 24 up and out into the vent area 30. FIG. 7 shows a lowered position where fluid bypasses the o-ring 24 by flowing only through the axial groove(s) 52 and into the circumferential groove 51, bypassing the o-ring 24 and exiting via into the vent 30.

All of these embodiments assume some clearance 70 (see FIG. 7), which is between the outer circumference of the lower valve disc 20 and the inner face of the valve body 14.

In the two embodiments described above, the system for moving the lower valve disc 29 axially is described as moving between three positions, including as one of the positions an intermediate, o-ring cleaning, position. These embodiments can actually have two variations with respect to the intermediate position.

In one set of embodiments, the structures described above can be stopped or paused at the intermediate o-ring cleaning position, for situations where it is desired to have a period of time of o-ring cleaning, and/or situations where it may be desired to have a higher flow level of cleaning fluid out of the vent.

However, in a second set of embodiments, any of the structures described above are moved continuously (e.g., at a substantially continuous rate) from the closed position past the intermediate position and to the controlled fluid venting position.

Accordingly, it will be appreciated that various embodiments of the invention encompass both systems that pause at the intermediate position and systems that move through the intermediate position at a continuous rate. Even for systems that move through the intermediate o-ring cleaning position at a continuous rate, it will be appreciated that a period of time will exist where the o-ring cleaning flow will occur. This period of time will depend on the dimensions of the circumferential o-ring cleaning groove and on the rate at which the lower valve disc 20 is being moved.

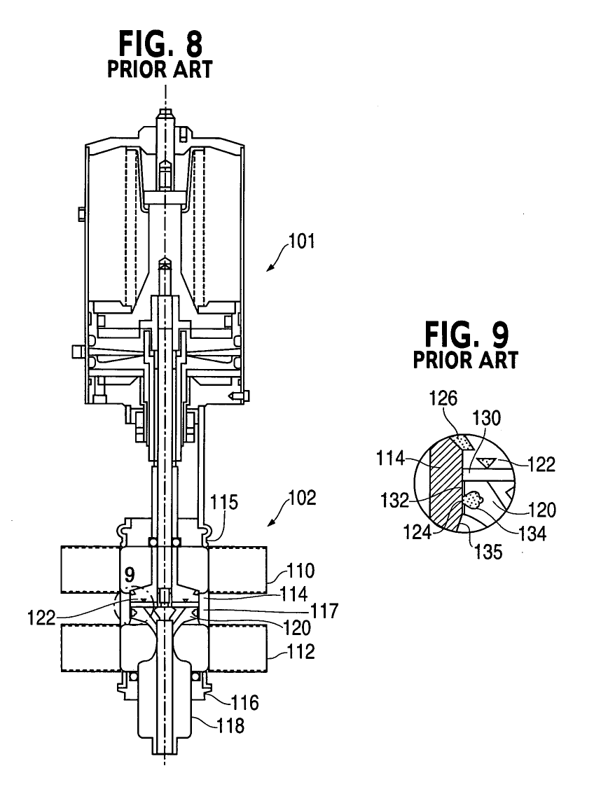

Some embodiments of the present invention provide many operative advantages. In particular, three discrete positions are provided, each having a specific function with respective flow of material into the vent 30. In one position, the valve is closed and no material flows into the vent 30. In another position, material flows completely around the periphery of the o-ring 24, thereby cleaning the entire outer periphery of the o-ring 24. In a third position, the flow into the vent 30 is throttled or controlled (although it does not cover the entire circumference of the o-ring 24). This can provide an advantage compared to the prior art devices depicted in FIGS. 8 and 9, wherein a transition is continually occurring between a closed and a wide open position caused by any degree of axial movement of the valve stem. Some embodiments of the present invention improve on difficulty of control of such a sensitive movement system, by providing three discrete positional ranges. Further, each positional range has some degree of axial tolerance, so that each of the three positions can be functionally achieved as desired while still having some degree of tolerance for slight axial mispositioning.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A valve apparatus, comprising:
a hollow valve body having an inner seat face;
a valve disc reciprocally moveable within the valve body;
a seal element disposed around the valve disc to contact the inner seat face of the valve body; and
a fluid control groove disposed on the seat face, the flow control groove comprising an annular circumferential groove portion, and a secondary groove portion.

2. The apparatus of claim 1, wherein the second groove portion is a helical groove that meets with the circumferential groove.

3. The apparatus of claim 1, wherein the secondary groove is a single axial groove that meets with the circumferential groove.

4. The apparatus of claim 1, wherein the secondary groove is two or more helical grooves that both meet with the circumferential groove.

5. The apparatus of claim 1, wherein the secondary groove is two or more axial grooves that meet with the circumferential groove.

6. The apparatus of claim 1, wherein the seal element comprises an elastomeric o-ring.

7. The apparatus of claim 1, wherein the valve body has a vent region that permits flow of fluid out of the valve body.

8. The apparatus of claim 1, wherein the valve disc is moveable between (i) a first position at which the seal element is seated against the seat face and prevents flow into the vent region, and (ii) a second position where the o-ring is disposed axially parallel to the circumferential groove region permitting flow around the o-ring, and (iii) a third position wherein the o-ring is disposed at the axial location of the secondary groove, and permits fluid flow past the o-ring via the secondary groove.

9. A valve apparatus, comprising:
a hollow valve body having an inner seat face;
a valve disc reciprocally moveable within the valve body;
sealing means disposed around the valve disc to contact the inner seat face of the valve body; and
a fluid controlling means disposed on the seat face, the flow control groove comprising an annular circumferential groove portion, and a secondary groove portion.

10. The apparatus of claim 9, wherein the second groove portion is a helical groove that meets with the circumferential groove.

11. The apparatus of claim 9, wherein the secondary groove is a single axial groove that meets with the circumferential groove.

12. The apparatus of claim 9, wherein the secondary groove is two or more helical grooves that both meet with the circumferential groove.

13. The apparatus of claim 9, wherein the secondary groove is two or more axial grooves that meet with the circumferential groove.

14. The apparatus of claim 9, wherein the sealing means comprises an elastomeric o-ring.

15. The apparatus of claim 9, wherein the valve body has a venting means that permits flow of fluid out of the valve body.

16. The apparatus of claim 9, wherein the valve disc is moveable from (i) a first position at which the seal element is seated against the seat face and prevents flow into the vent region, through (ii) a second position where the o-ring is disposed axially parallel to the circumferential groove region permitting flow around the o-ring, and into (iii) a third position wherein the o-ring is disposed at the axial location of the secondary groove, and permits fluid flow past the o-ring via the secondary groove.

17. A method of controlling flow in a valve apparatus, comprising:
moving a device comprising:
a hollow valve body having an inner seat face;
a valve disc reciprocally moveable within the valve body;
a seal element disposed around the valve disc to contact the inner seat face of the valve body; and
a fluid control groove disposed on the seat face, the flow control groove comprising an annular circumferential groove portion, and a secondary groove portion,
wherein the disc is moved from (i) a first position at which the seal element is seated against the seat face and prevents flow into the vent region, through (ii) a second position where the o-ring is disposed axially parallel to the circumferential groove region permitting flow around the o-ring, and into (iii) a third position wherein the o-ring is disposed at the axial location of the secondary groove, and permits fluid flow past the o-ring via the secondary groove.

18. The method of claim 17, wherein the second groove portion is a helical groove that meets with the circumferential groove.

19. The method of claim 17, wherein the secondary groove is a single axial groove that meets with the circumferential groove.

20. The method of claim 17, wherein the secondary groove is two or more helical grooves that both meet with the circumferential groove.

21. The method of claim 17, wherein the secondary groove is two or more axial grooves that meet with the circumferential groove.

22. The method of claim 17, wherein the disc is moved in a single continuous motion from the first position to the third position, and during this single continuous motion the disc passes through the second position.

23. The method of claim 17, further comprising the step of pausing the disc at the second position before continuing movement of the disc to the third position.
